(19) United States
(12) Patent Application Publication
(10) Pub. No.: US 2024/0216947 A1
(43) Pub. Date: Jul. 4, 2024

(54) MANUFACTURING METHOD OF COMPOSITE COPPER FOIL

(71) Applicant: NAN YA PLASTICS CORPORATION, TAIPEI (TW)

(72) Inventors: Te-Chao Liao, TAIPEI (TW); Chun-Che Tsao, TAIPEI (TW); Ren-Yu Liao, TAIPEI (TW)

(73) Assignee: NAN YA PLASTICS CORPORATION, TAIPEI (TW)

(21) Appl. No.: 18/184,695

(22) Filed: Mar. 16, 2023

(30) Foreign Application Priority Data
Dec. 30, 2022 (TW) 111150787

(51) Int. Cl. B05D 1/38; B05D 5/12; B05D 7/14

(52) U.S. Cl. CPC B05D 1/38; B05D 5/12; B05D 7/14; B05D 2202/45; B05D 2252/10; B05D 2401/40; B05D 2601/28

(57) ABSTRACT

A manufacturing method of composite copper foil includes the following steps: providing a copper foil, wherein the copper foil has a first surface and a second surface opposite to each other; performing a surface treatment with a surface treatment solution to form a first surface treatment layer on the first surface of the copper foil; and forming a first lithium metal layer on the first surface treatment layer. Another manufacturing method of composite copper foil includes the following steps: providing a copper foil, wherein the copper foil has a first surface and a second surface opposite to each other; preparing a conductive material; adding a filling material, an adhesive material and a solvent to the conductive material to form a slurry; coating the slurry on the first surface of the copper foil to form a first conductive layer.

### CROSS-REFERENCE TO RELATED APPLICATION

This application claims the priority benefit of Taiwan application serial no. 111150787, filed on Dec. 30, 2022. The entirety of the above-mentioned patent application is hereby incorporated by reference herein and made a part of this specification.

### BACKGROUND

### Technical Field

The present invention relates to a manufacturing method of a composite copper foil, and in particular relates to a manufacturing method of a composite copper foil capable of producing a composite copper foil with a thinner thickness.

### Description of Related Art

In addition to the solidification of the electrolyte, the development problem of the current solid-state battery is that the high-density solid-state electrolyte often affects the gram capacity of the battery, which in turn leads to a decrease in the energy density of the battery. Therefore, there is an urgent need to develop a solid-state battery with light weight, high gram capacity and high energy density.

### SUMMARY

The present invention provides a manufacturing method of composite copper foil, which can produce composite copper foil with thinner thickness, and can make the solid-state battery using this composite copper foil as negative electrode have the effect of the safety due to avoiding the formation of lithium dendrites and higher energy density (or gram capacitance).

The manufacturing method of the composite copper foil of the present invention includes the following steps. A copper foil is provided, wherein the copper foil has a first surface and a second surface opposite to each other. A surface treatment is performed with a surface treatment solution to form a first surface treatment layer on the first surface of copper foil. A first lithium metal layer is formed on the first surface treatment layer.

In an embodiment of the present invention, the surface treatment solution includes polyvinylidene fluoride, zinc, chromium, nickel, tin, sulfur, graphene, silane or a combination thereof.

In an embodiment of the present invention, the thickness of the lithium metal layer is 1 micron to 30 microns.

In an embodiment of the present invention, the above manufacturing method further includes the following steps. The surface treatment is performed with the surface treatment solution to form a second surface treatment layer on the second surface of the copper foil. A second lithium metal layer is formed on the second surface treatment layer.

The manufacturing method of the composite copper foil of the present invention includes the following steps. A copper foil is provided, wherein the copper foil has a first surface and a second surface opposite to each other. A conductive material is prepared. A filling material, an adhesive material and a solvent are added to the conductive material to form a slurry. The slurry is coated on the first surface of copper foil to form a first conductive layer.

In an embodiment of the present invention, the above-mentioned method for preparing the conductive material includes: forming a passivation layer on a surface of lithium metal powder to obtain the conductive material.

In an embodiment of the present invention, the material of the passivation layer includes silicon, fluorine or a combination thereof.

In one embodiment of the present invention, based on a total weight of the above slurry, a content of the conductive material is 5 wt % to 20 wt %, a content of the filling material is 1 wt % to 10 wt %, a content of the adhesive material is 5 wt % to 20 wt %, and a content of the solvent is 60 wt % to 89 wt %.

In an embodiment of the present invention, the thickness of the first conductive layer is 1 micron to 30 microns.

In an embodiment of the present invention, the above manufacturing method further includes: coating the slurry on the second surface of the copper foil to form a second conductive layer.

Based on the above, in the manufacturing method of the composite copper foil according to an embodiment of the present invention, by performing the surface treatment on the copper foil (that is, forming a first surface treatment layer with lithiophilicity on the copper foil), or by mixing the lithium metal powder with the filling material, the adhesive material and the solvent to form a slurry enables the lithium metal (i.e., the first lithium metal layer or first conductive layer) to be formed on the copper foil. In addition, by forming lithium metal on the copper foil to obtain a thinner composite copper foil, the lithium metal formed on the copper foil can have a uniform, specific morphology (such as a specific lattice arrangement) and the thinner thickness, such that the solid-state battery using the composite copper foil as the negative electrode can avoid the safety hazard caused by the formation of lithium dendrites, and have the effects of light weight, high gram capacity and high energy density.

In order to make the aforementioned features and advantages of the present invention more comprehensible, embodiments are illustrated in detail hereinafter.

### BRIEF DESCRIPTION OF THE DRAWINGS

FIG. 1A to FIG. 1C are schematic cross-sectional views of the manufacturing method of the composite copper foil of the first embodiment of the present invention.

FIG. 2 is a schematic cross-sectional view of the manufacturing method of the composite copper foil according to the second embodiment of the present invention.

FIG. 3 is a schematic cross-sectional view of the manufacturing method of the composite copper foil according to the third embodiment of the present invention.

FIG. 4 is a schematic cross-sectional view of a manufacturing method of a composite copper foil according to a fourth embodiment of the present invention.

### DESCRIPTION OF THE EMBODIMENTS

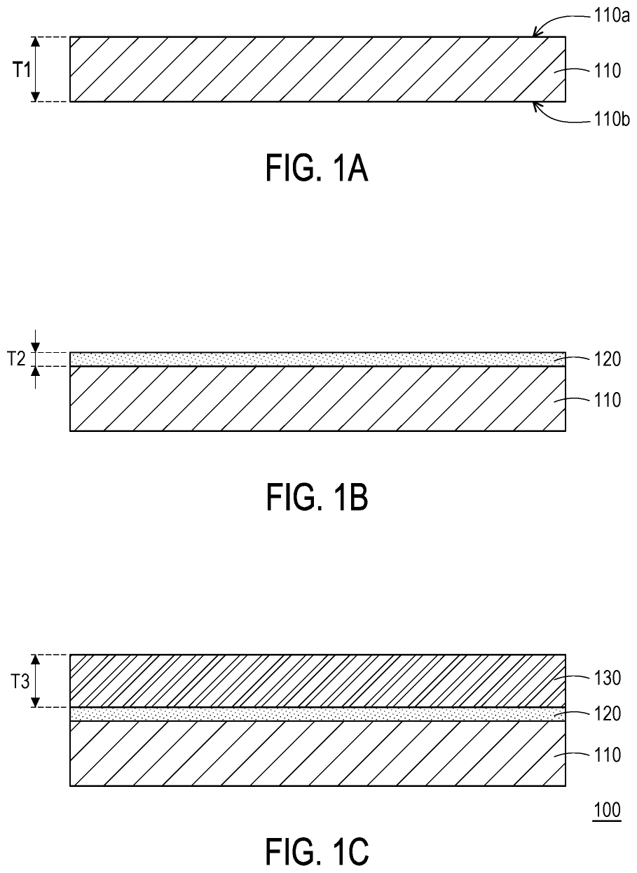

FIG. 1A to FIG. 1C are schematic cross-sectional views of the manufacturing method of the composite copper foil of the first embodiment of the present invention. In this embodiment, the manufacturing method of the composite copper foil 100 may include the following steps.

First, referring to FIG. 1A, a copper foil 110 is provided. The copper foil 110 has a first surface 110a and a second surface 110b opposite to each other. The thickness T1 of the copper foil 110 ranges, for example, from 3 microns (μm) to 20 microns, but is not limited thereto.

Then, please refer to FIG. 1B, a surface treatment is performed with a surface treatment solution to form a first surface treatment layer 120 on the first surface 110a of the copper foil 110. The first surface treatment layer 120 may contact the copper foil 110. The first surface treatment layer 120 has lithiophilicity. The thickness T2 of the first surface treatment layer 120 is, for example, less than 1 micron, but is not limited thereto. In this embodiment, the surface treatment solution may include polyvinylidene fluoride, zinc, chromium, nickel, tin, sulfur, graphene, silane or combinations thereof, but is not limited thereto. In this embodiment, the surface treatment method is, for example, a pre-lithiation surface treatment method, and includes, for example, the following steps: first soaking the copper foil 110 in the surface treatment solution or applying the surface treatment solution on the first surface 110a of the copper foil 110, and then dried to form a first surface treatment layer 120 with lithiophilicity by generating bonding and surface tension.

Then, referring to FIG. 1C, a first lithium metal layer 130 is formed on the first surface treatment layer 120 to obtain a composite copper foil 100. The first lithium metal layer 130 and the copper foil 110 are respectively located on two sides of the first surface treatment layer 120. The first lithium metal layer 130 may contact the first surface treatment layer 120. The thickness T3 of the first lithium metal layer 130 ranges, for example, from 1 micron to 30 microns, but is not limited thereto. In this embodiment, the method for forming the first lithium metal layer 130 on the first surface treatment layer 120 includes, for example, the following steps: coating molten lithium metal on the surface of the first surface treatment layer 120, or depositing lithium metal on the surface of first surface treatment layer 120.

Generally, the lithium metal layer cannot be directly formed on the copper foil due to poor adhesion between the lithium metal and the copper foil. However, in the manufacturing method of the composite copper foil of this embodiment, by performing the surface treatment on the copper foil 100 (that is, forming the first surface treatment layer 120 with lithiophilicity on the copper foil 100), lithium (i.e., the first lithium metal layer 130) can be formed on the copper foil 100.

The composite copper foil 100 of this embodiment may be applied to a solid-state battery. For example, the composite copper foil 100 may be used as a negative electrode of a solid-state battery, but is not limited thereto. In addition, using thicker copper foil or graphene as the negative electrode of solid-state batteries, the solid-state batteries arise the problem of lower gram capacity and energy density, while in this embodiment, by forming lithium metal on the copper foil 100 to obtain a thinner composite copper foil 100 (for example: the thickness of the composite copper foil 100 is generally ⅕ to 1/10 of the thickness of the negative electrode of a solid-state battery using copper foil or graphene), the solid-state battery using the composite copper foil 100 as the negative electrode can have the effects of light weight, high gram capacity and high energy density.

In addition, compared to the general situation where only thicker lithium metal is used as the negative electrode of solid-state batteries, which may easily lead to endanger safety due to the generation of lithium dendrites, by forming lithium metal on copper foil 100 in this embodiment, the lithium metal formed on the copper foil 100 can have a uniform, specific morphology (such as a specific lattice arrangement) and a relatively thin thickness (such as 1 micron to 30 microns), so that the solid-state battery using the composite copper foil 100 of this embodiment as a negative electrode can avoid the safety hazard caused by the formation of lithium dendrites.

Other embodiments are listed below for illustration. It must be noted here that the following embodiments use the reference numerals and part of the content of the previous embodiments, wherein the same reference numerals are used to denote the same or similar components, and descriptions of the same technical content are omitted. For the description of omitted parts, reference may be made to the foregoing embodiments, and the following embodiments will not be repeated.

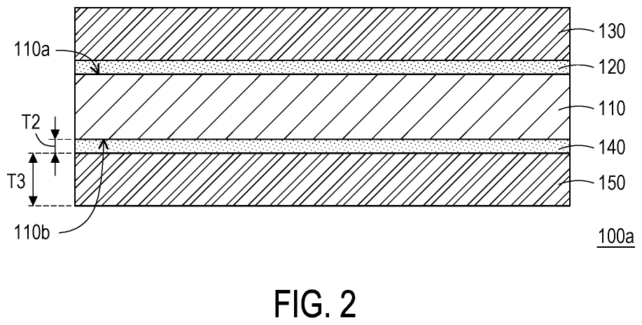

FIG. 2 is a schematic cross-sectional view of the manufacturing method of the composite copper foil according to the second embodiment of the present invention. FIG. 2 is a continuation of the steps shown in FIG. 1A to FIG. 1C. The same or similar components in the embodiment of FIG. 2 and the embodiment of FIG. 1A to FIG. 1C can be made by using the same materials or methods, so the following descriptions of the same and similar in the two embodiments will not be repeated, and the mainly differences between the two embodiments will be described.

Please refer to FIG. 1C and FIG. 2, after forming the composite copper foil 100 in FIG. 1C, the surface treatment solution used in FIG. 1B is used to perform the surface treatment on the second surface 110b of the copper foil 110 to form a second surface treatment layer 140 on the second surface 110b of the copper foil 110. The thickness T2 of the second surface treatment layer 140 is, for example, less than 1 micron, but is not limited thereto. Next, in a manner similar to FIG. 1C, a second lithium metal layer 150 is formed on the second surface treatment layer 140 to obtain the composite copper foil 100a of this embodiment. The copper foil 110 and the second lithium metal layer 150 may be located on two sides of the second surface treatment layer 140 respectively. The thickness T3 of the second lithium metal layer 150 ranges, for example, from 1 micron to 30 microns, but is not limited thereto.

In some embodiments, the manufacturing method of the composite copper foil 100a in FIG. 2 may also adopt the following steps: first providing the copper foil 110; then, performing a surface treatment on the first surface 110a and the second surface 110b of the copper foil 110 using the surface treatment solution to form the first surface treatment layer 120 and the second surface treatment layer 140 on the first surface 110a and the second surface 110b of the copper foil 110 respectively; and then forming a first lithium metal layer 130 on the first surface treatment layer 120, and a second lithium metal layer 150 on the second surface treatment layer 140 to obtain a composite copper foil 100a.

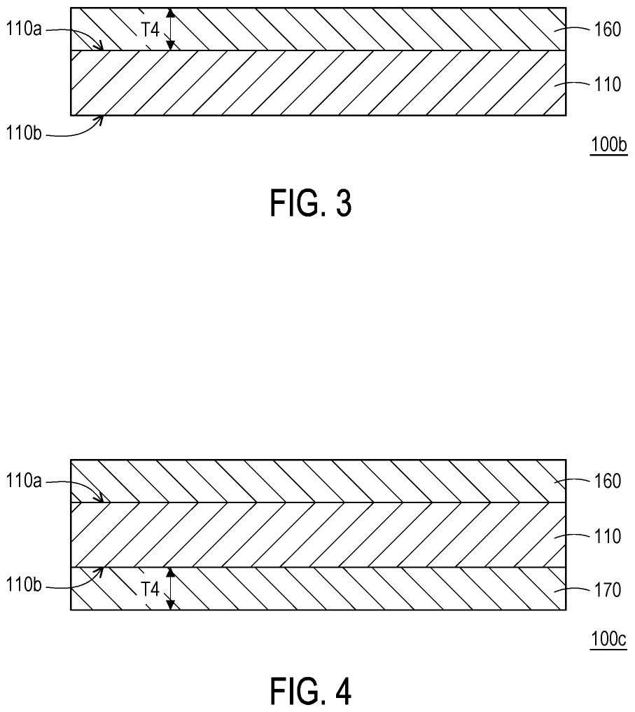

FIG. 3 is a schematic cross-sectional view of the manufacturing method of the composite copper foil according to the third embodiment of the present invention. FIG. 3 is a continuation of FIG. 1A and replaces the steps of FIG. 1B to FIG. 1C. The same or similar components in the embodiment of FIG. 2 and the embodiment of FIG. 1A to FIG. 1C can be made by using the same materials or methods, so the following descriptions of the same and similar in the two embodiments will not be repeated, and the mainly differences between the two embodiments will be described.

Please refer to FIG. 3, different from the composite copper foil 100 in FIG. 1C, the composite copper foil 100b of this embodiment does not have the surface treatment layer of FIG. 1C, and in the composite copper foil 100b of this embodiment, a first conductive layer 160 replaces the first lithium metal layer 130 in FIG. 1C.

Specifically, the manufacturing method of the composite copper foil 100b of this embodiment may include the following steps.

First, a copper foil 110 as shown in FIG. 1A is provided.

Then, a conductive material is prepared. The conductive material includes lithium metal powder and a passivation layer disposed on the surface of the lithium metal powder. In this embodiment, the lithium metal powder can be prevented from reacting with the atmosphere by coating the surface of the lithium metal powder with the passivation layer. In this embodiment, the method for preparing the conductive material may include the following steps: forming a passivation layer on the surface of the lithium metal powder to obtain the conductive material. The material of the passivation layer may include silicon, fluorine or a combination thereof, but is not limited thereto.

Then, a filling material, an adhesive material and a solvent are added to the conductive material to form a slurry. The filling material may include silane, fluorinating agent (for example: polytetrafluoroethylene (PTFE), polyisobutylene (PIB), polyimide (PI), N-fluorobisbenzenesulfonamide (NSFI) or 2,2-difluoro-1,3-dimethylimidazoline (DFI)) or a combination thereof, but is not limited thereto. The adhesive material may include polyvinylidene fluoride (PVDF), graphene, carbon nanotubes, tin, sulfur, zinc, chromium, nickel or combinations thereof, but is not limited thereto. The solvent may include N-methylpyrrolidone (NMP), ethyl acetate (EAc), acetone, hexane, dimethylacetamide (DMAc), dimethylformamide (DMF), butanone (MEK) or a combination thereof, but is not limited thereto.

In this embodiment, based on the total weight of the slurry, the content of the conductive material is 5 wt % to 20 wt %, preferably 5 wt % to 15 wt %. In detail, if the content of the conductive material is less than 5 wt %, the conductivity of the slurry will be deteriorated; if the content of the conductive material is higher than 15 wt %, the adhesiveness and dispersibility of the slurry will be poor.

In this embodiment, based on the total weight of the slurry, the content of the filling material is 1 wt % to 10 wt %, preferably 2 wt % to 5 wt %. Specifically, if the content of the filling material is less than 2 wt %, there will be too many ineffective components in the slurry; if the content of the filling material is higher than 5 wt %, the dispersion effect of the filling material will not be exerted.

In this embodiment, based on the total weight of the slurry, the content of the adhesive material is 5 wt % to 20 wt %, preferably 15 wt % to 20 wt %. Specifically, if the content of the adhesive material is less than 15 wt %, the adhesiveness of the slurry will be insufficient; if the content of the adhesive material is higher than 20 wt %, the conductivity of the slurry will be deteriorated.

In this embodiment, based on the total weight of the slurry, the content of the solvent is 60 wt % to 89 wt %, preferably 70 wt % to 80 wt %. In detail, if the content of the solvent is lower than 70 wt %, the solubility of the slurry will be insufficient and the slurry will too viscous and difficult to process; if the content of the solvent is higher than 80 wt %, the slurry will be too thin and difficult to coat.

Then, please refer to FIG. 3, the slurry is coated on the first surface 110a of the copper foil 110 to form the first conductive layer 160 and obtain the composite copper foil 100b. The thickness T4 of the first conductive layer 160 ranges, for example, from 1 micron to 30 microns, but is not limited thereto.

In the manufacturing method of the composite copper foil of this embodiment, by forming a passivation layer on the surface of the lithium metal powder, and mixing the lithium metal powder with the filling material, the adhesive material and the solvent to form the slurry, the first conductive layer 160 can be directly formed on the copper foil 100.

FIG. 4 is a schematic cross-sectional view of a manufacturing method of a composite copper foil according to a fourth embodiment of the present invention. FIG. 4 is a continuation of the steps in FIG. 3. The same or similar components in the embodiment of FIG. 4 and the embodiment of FIG. 3 can be made using the same materials or methods, so the following descriptions of the same and similar in the two embodiments will not be repeated, and the mainly differences between the two embodiments will be described.

Please refer to FIG. 3 and FIG. 4, after forming the composite copper foil 100b in FIG. 3, the slurry used in FIG. 3 is coated on the second surface 110b of the copper foil 110 to form a second conductive layer 170, and obtain a composite copper foil 100c of this embodiment. The first conductive layer 160 and the second conductive layer 170 may be located on two sides of the copper foil 110 respectively. The thickness T4 of the second conductive layer 170 ranges, for example, from 1 micron to 30 microns, but is not limited thereto.

In some embodiments, the manufacturing method of the composite copper foil 100c in FIG. 4 may also adopt the following steps: first providing the copper foil 110; then, coating the slurry on the first surface 110a and the second surface 110b of the copper foil 110 to simultaneously form the first conductive layer 160 and the second conductive layer 170, and obtain the composite copper foil 100c of this embodiment.

In the following, Examples are used to prove that when using the composite copper foil produced by the above-mentioned manufacturing method of composite copper foil as a negative electrode of a solid-state battery, the effect of the safety due to avoiding the formation of lithium dendrites and higher energy density (or gram capacitance) can be achieve. However, the following examples are not intended to limit the present invention.

### Example 1

The fluorinating agent (i.e., filling material), polyvinylidene fluoride (i.e., adhesive material), acetone and dimethylacetamide (i.e., solvent) were added to lithium powder (i.e., conductive material), and after mixing uniformly, a slurry was formed. The lithium powder includes lithium metal powder and a passivation layer disposed on the surface of the lithium metal powder, and based on the total weight of the lithium powder as 100%, the content of the lithium metal powder was about 97-98%. In addition, based on the total weight of the slurry as 100%, the contents of lithium powder, fluorinating agent, polyvinylidene fluoride, acetone, and dimethylacetamide were 10%, 2%, 10%, 8%, and 70%. Then, the slurry was coated on the copper foil to form a lithium layer (i.e., first conductive layer) with a thickness of 5 microns, and a composite copper foil was obtained.

### Example 2

The composite copper foil of Example 2 was prepared in the same steps as in Example 1, the difference lies in the content of the components used. The component contents used in Example 2 is recorded in Table 1.

### Comparative Example 1 to Comparative Example 4

The composite copper foils of Comparative Example 1 to Comparative Example 4 were prepared by the same procedure as that of Example 1, and the difference lies in the content of components used in each Comparative Example. The component contents used in Comparative Example 1 to Comparative Example 4 are recorded in Table 1.

After the composite copper foils prepared by the above-mentioned Examples and Comparative Examples were used as the negative electrodes and applied to the NMC622 assembled full battery (about 170 mAh/g), the capacity retention (CR) %, coulombic efficiency (CE) % and lithium dendrite were measured after 200 cycles (1C), the measurement results are recorded in Table 1.

TABLE 1

| | Example | Example | Comparative | Comparative | Comparative | Comparative |
|---|---|---|---|---|---|---|
| | 1 | 2 | Example 1 | Example 2 | Example 3 | Example 4 |
| lithium powder | 10% | 10% | 20% | 10% | 25% | 5% |
| fluorinating agent | 2% | 2% | 2% | 12% | 2% | 2% |
| polyvinylidene | 10% | 10% | 20% | 10% | 5% | 25% |
| fluoride | | | | | | |
| acetone | 8% | 8% | 5% | 8% | 8% | 8% |
| dimethylacetamide | 70% | 70% | 53% | 60% | 60% | 60% |
| Thickness of | 5 | 20 | 20 | 20 | 20 | 20 |
| lithium layer (μm) | | | | | | |
| CR % | 85.5% | 84.9% | 45.0% | 36.2% | 39.7% | 34.8% |
| CE % | 98% | 97.5% | 95% | 90% | 92% | 93% |
| lithium dendrite | none | none | yes | yes | yes | yes |

It can be seen from the results in Table 1 that when the content of lithium powder is excessive, the thickness of the lithium layer will be increased, lithium dendrites will be generated, and the capacity retention will be reduced. When the content of the fluorinating agent is excessive, the thickness of the lithium layer will be increased, lithium dendrites will be generated, and the capacity retention will be reduced. When the content of the polyvinylidene fluoride is excessive, the thickness of the lithium layer will be increased, lithium dendrites will be generated, and the capacity retention will be reduced. When the contents of acetone and dimethylacetamide are too small, the thickness of the lithium layer will be increased, lithium dendrites will be generated, and the capacity retention will be reduced.

To sum up, in the manufacturing method of the composite copper foil according to an embodiment of the present invention, by performing the surface treatment on the copper foil (that is, forming a first surface treatment layer with lithiophilicity on the copper foil), or by mixing the lithium metal powder with the filling material, the adhesive material and the solvent to form a slurry enables the lithium metal (i.e., the first lithium metal layer or first conductive layer) to be formed on the copper foil. In addition, by forming lithium metal on the copper foil to obtain a thinner composite copper foil, the lithium metal formed on the copper foil can have a uniform, specific morphology (such as a specific lattice arrangement) and the thinner thickness, such that the solid-state battery using the composite copper foil as the negative electrode can avoid the safety hazard caused by the formation of lithium dendrites, and have the effects of light weight, high gram capacity and high energy density.

Although the present invention is disclosed with reference to embodiments above, the embodiments are not intended to limit the present invention. Any person of ordinary skill in the art may make some variations and modifications without departing from the spirit and scope of the invention, and therefore, the protection scope of the present invention should be defined in the following claims.

What is claimed is:

1. A method for manufacturing a composite copper foil, comprising:
providing a copper foil, wherein the copper foil has a first surface and a second surface opposite to each other;
performing a surface treatment with a surface treatment solution to form a first surface treatment layer on the first surface of the copper foil; and
forming a first lithium metal layer on the first surface treatment layer.

2. The manufacturing method according to claim 1, wherein the surface treatment solution includes polyvinylidene fluoride, zinc, chromium, nickel, tin, sulfur, graphene, silane or a combination thereof.

3. The manufacturing method according to claim 1, wherein a thickness of the lithium metal layer is 1 micron to 30 microns.

4. The manufacturing method according to claim 1, further comprising:
performing the surface treatment with the surface treatment solution to form a second surface treatment layer on the second surface of the copper foil; and
forming a second lithium metal layer on the second surface treatment layer.

5. A method for manufacturing a composite copper foil, comprising:
providing a copper foil, wherein the copper foil has a first surface and a second surface opposite to each other;
preparing a conductive material;
adding a filling material, an adhesive material and a solvent to the conductive material to form a slurry; and
coating the slurry on the first surface of the copper foil to form a first conductive layer.

6. The manufacturing method according to claim 5, wherein the method for preparing the conductive material comprises:
forming a passivation layer on a surface of lithium metal powder to obtain the conductive material.

7. The manufacturing method according to claim 5, wherein a material of the passivation layer includes silicon, fluorine or a combination thereof.

8. The manufacturing method according to claim 5, wherein based on a total weight of the slurry, a content of the conductive material is 5 wt % to 20 wt %, a content of the filling material material is 1 wt % to 10 wt %, and a content of the adhesive material is 5 wt % % to 20 wt %, and a content of the solvent is 60 wt % to 89 wt %.

9. The manufacturing method according to claim 5, wherein a thickness of the first conductive layer is 1 micron to 30 microns.

10. The manufacturing method according to claim 5, further comprising:
coating the slurry on the second surface of the copper foil to form a second conductive layer.
